(19) United States
(12) Patent Application Publication
(10) Pub. No.: US 2012/0032086 A1
(43) Pub. Date: Feb. 9, 2012

(54) HAND-HELD GAMMA RAY SCANNER

(76) Inventor: Farhad Daghighian, Santa Monica, CA (US)

(21) Appl. No.: 13/023,469

(22) Filed: Feb. 8, 2011

Related U.S. Application Data
(60) Provisional application No. 61/302,456, filed on Feb. 8, 2010.

(51) Int. Cl. G01T 1/166

(52) U.S. Cl. 250/363.02

(57) ABSTRACT

A hand held gamma ray scanner comprises a one dimensional array of SSPM detectors coupled to a scintillator slab or an array of scintillators. A position tracker is attached to this “scanner” enabling software in a support system to acquire the position of the scanner, as well as 1-D images of the distribution of gamma rays received from radiation labeled tissue and generate an output signal in real time.

This application claims benefit of U.S. Provisional Application No. 61/302,456, filed Feb. 8, 2010.

### BACKGROUND

Anatomy and physiology are often altered during surgery. Thus, results of preoperative scans often do not fully reflect the present state of the patient during a procedure as the patient physiology can be considered to be a “moving target” during the procedure. For this reason mobile or surgical room x-ray C-arm and ultrasound units are being used during many surgeries. With the advances in molecular imaging, an intra-operative gamma ray imager would improve the “real-time” knowledge of the surgeon.

The utility of single-detector gamma probes are limited to cases in which the background radioactivity is much lower when compared to that of the lesion. It is easier to identify a “hot spot” in a gamma ray image than to rely on guidance from an audio output typically generated by the use of a gamma probe. In particular, the eye can discern a 1.5 to 1 contrast in an image. In the last 15 years various intra-operative gamma cameras have been developed but they are excessively heavy, prohibitively expensive and difficult for the surgeon to set-up, position, and to correlate the images with the anatomy.

### SUMMARY

A hand held gamma ray scanner comprises a one dimensional array of SSPM detectors coupled to a scintillator slab or an array of scintillators. A position tracker is attached to this “scanner” enabling the software to acquire the position of the scanner, as well as 1-D images of the distribution of radioactivity in real time.

### BRIEF DESCRIPTION OF FIGURES

FIG. 1 is a perspective view of an interoperative scanner incorporating features of the invention.

Figure shows the interoperative scanner of FIG. 1q attached to a handle being used in a surgical procedure.

FIG. 3 shows a second embodiment of the interoperative scanner configured for a single point scan.

FIGS. 4 a, b and show schematically a gamma-ray scanner incorporating features of the invention for use with Tc-99m.

FIGS. 5a, b and c schematically a gamma-ray scanner incorporating features of the invention for 511 keV.

FIG. 6 schematically illustrates the use of the intraoperative scanner in a 1-D mode.

FIG. 7 schematically illustrates the use of the intraoperative scanner in a 3-D mode.

FIG. 8 schematically illustrates the use of the intraoperative scanner in a rotational mode.

FIG. 9 is a schematic representation of the generation of a light pattern on a body organ using a laser and recording the contour images using a CCD camera.

FIG. 10 is a schematic representation of another techniques of generating a contoured light image on an object.

FIG. 11 shows an example of a contour light image projected on the face of an individual.

FIG. 12 shows a schematic representation of a scanner system with a gamma scanner incorporating features of the invention mounted therein.

FIG. 13 is a schematic representation of a rotational gamma scanner mounted with a tube.

FIG. 14 shows the addition of a laser pointer to the hand held PET scanner.

### DETAILED DISCUSSION

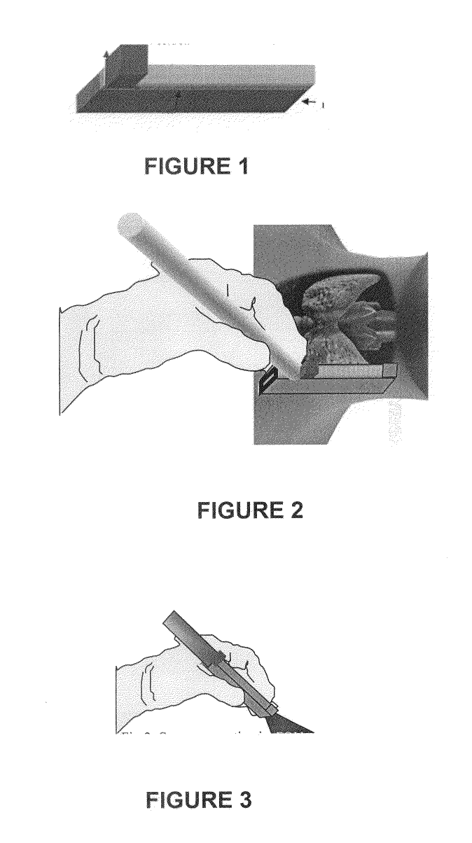

Disclosed is an interoperative scanner, shown in FIGS. 1 and 2, that will alleviate the above problems. It is essentially a one dimensional array of SSPM detectors 12 coupled to a scintillator slab or an array of scintillators 14. A position tracker 16 is attached to this “scanner” enabling the software to acquire the position of the scanner, as well as 1-D images of the distribution of radioactivity in real time. The surgeon holds scanner in his/her hand 18 and freely moves and scans the suspicious areas on or in the body. Meanwhile optical cameras can take pictures of the field and the software then superimposes the nuclear images onto the optical images of the surgical field to form composite images. The composite images are displayed on a flat screen next to the surgical field or, using a DLP projector, directly to the field of view of the surgeon so that the surgeon is not interrupted by having to look up to the display screen. Further, the DLP projector with the use of a position tracker is capable of projecting the nuclear images directly on the surgical field that was scanned. For example, one such device recently developed by Texas Instruments, called the DLP® Pico™ Projector, has with direct connection to the computer, a synchronized signal output, high speed pattern rates, and an auxiliary connector.

This hand held gamma ray scanner opens new possibilities in intra-operative nuclear medicine that has not been possible with existing 2-dimentional cameras, namely:
a. Light weight, so the surgeon can freely move his/her hand while the scanner is working, and the position tracking system is registering the position and orientation of the scanner in order to form an image.
b. Ergonomic and maneuverable during surgery by the surgeon alone.
c. Capability of scanning non-planar surfaces (such as the neck);
d. Low cost with a cost to customer ˜$20000 for Tc-99m, $40000 for F-18;
e. Capable of linear scanning as well as angular scanning (such as rotating while inside an incision);
f. Can enter the body, through a 15 mm diameter laparo-port, trans-rectally, or trans-vaginally;
g. Possibility of building such a scanner for 511 keV without needing an excessively heavy collimator.

The basic detector element is based on the use of a novel solid state light detector called the Solid State Photo-multiplier (SSPM) or the Silicon Photo-multiplier (SiPM) and LYSO scintillation crystals. The SSPM is a novel compact detector with gains greater that one million, at a low operating voltage ˜50 V. Significant needs for such a scanner include:
a—Sentinel node imaging in breast and melanoma prior to incision in order to determine how many sentinel nodes are present. Then after the incision, confirming and documenting that all the sentinel nodes are removed.
b—Imaging of thyroid cancer, parathyroid adenomas, head-neck sentinel nodes in the operation room.
c—Intraoperative imaging of FDG avid tumors for localization of foci of activity shown on the pre-operative PET scans, as well as possibly detecting foci missed by PET.
d—Laparoscopic nuclear imaging for detection of sentinel nodes of prostate and GI cancers.
e—Trans-rectal imaging of the prostate cancer recurrence using Tc-99m labeled tracers.

Described herein is a gamma-ray scanner utilizing a 1-D array of SSPM-scintillator detectors optimized for 140 keV of Tc99m. A similar scanner with scintillator and shielding appropriate for 511 keV was also assembled. These systems were tested under realistic conditions to optimize lesion detection with Tc-99m and F-18.

These devices were evaluated with an incorporated position tracker. The surface-rendering systems using the gamma ray scanners had the resulting nuclear image merged with the computer generated 3D rendition of the scanned area, as well as with the visual pictures of the surgical field; for real time representation to the surgeon.

Advantages over two-dimensional planar gamma cameras for operating room include, but are not limited to, light weight devices:
a—so the surgeon can freely move his/her hand while the scanner is working and position tracking system is registering the position of the scanner in order to form an image.
b—The devices are ergonomic and maneuverable during surgery by the surgeon alone;
c—Capability of scanning non-planar surfaces (such as the neck)
d—Low cost; list price to customer ˜$20000 for Tc-99m, $40000 for F-18.
e—The scanner can function as a single-detector gamma probe (FIG. 2), by placing an extra detector with a field of view along the axis of the scanner and perpendicular to the field of view of the detector array. This can be achieved with minimal additional cost, and would make this product an economically attractive substitute to a conventional single-detector gamma probe.
f—Capable of linear scanning as well as angular scanning (such as rotating while inside an incision);
g—Due to its dimensions, the low-energy gamma-ray scanner can enter the body, through a 15 mm diameter laparo-port, trans-rectally, or trans-vaginally.
h—Possibility of building such a scanner for 511 keV without needing an excessively heavy collimator.

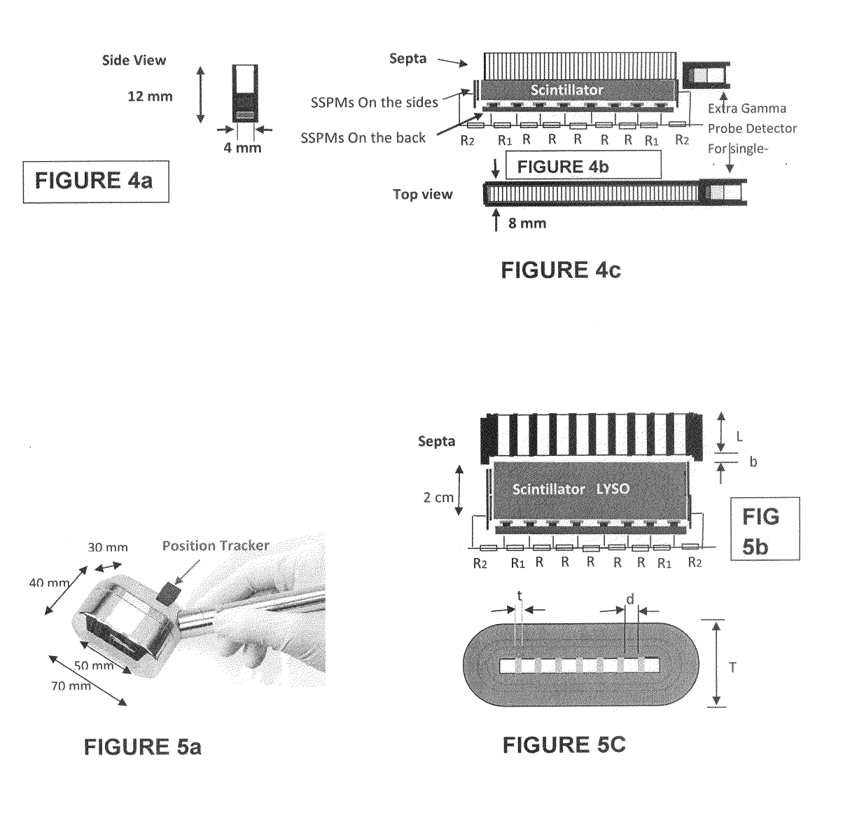

The basic detector element 11 is based on the use of a novel solid state light detector referred to as a Solid State Photo-multiplier (SSPM) or the Silicon Photo-multiplier (SiPM) 12 coupled to LYSO scintillation crystals 14. The SSPM is a compact novel detector with gains greater that one million, at a low operating voltage ˜50 V. (See FIGS. 3a, 3b, 3c, 4a, 4b, and 4c). Applications of the proposed Scanner 10 include:
a. Sentinel node imaging in breast and melanoma prior to incision in order to determine how many sentinel nodes are present. Then after the incision, confirming and documenting that all the sentinel nodes are removed.
b. Imaging of thyroid cancer, parathyroid adenomas, head-neck sentinel nodes in the operation room.
c. Intraoperative imaging of FDG avid tumors for localization of foci of activity shown on the pre-operative PET scans, as well as possibly detecting foci missed by PET.
d. Laparoscopic nuclear imaging for detection of sentinel nodes of prostate and GI cancers.
e. Trans-rectal imaging of the prostate cancer recurrence using Tc-99m labeled tracers.

### Confirmation and Documentation of Complete Sentinel Node Removal

Sentinel lymph node (SLN) biopsy is now standard practice in the management of melanoma and breast cancer patients. Localization protocols vary in complexity and rates of success. The least complex involve only intraoperative gamma counting of radiotracer uptake; the most complex involve preoperative gamma imaging in nuclear medicine suite, followed by intraoperative single-detector gamma probe counting. In 15-20% of cases; searching with a single-detector gamma probe results in the detection of a second or third sentinel node. The sentinel node found first may not contain any tumor cells, but those found afterward may bear cancer cells. Currently the patient does not receive a post-operative gamma camera image, so it is not clear that all sentinel nodes were removed for examination. This is dangerous, because the sentinel node that was missed may be the cancerous one and as a result the patient is miss-diagnosed as free of metastasis. This significant error can be avoided if a post-operative gamma camera scan is acquired. Unfortunately it is not practical and cost efficient to move the patient to nuclear medicine suite, or to purchase a (>$100,000) portable small camera for this purpose. The hand held scanner 10 described addresses this need because it is available as a single-detector probe at a price of $20,000.

### Applications in Head & Neck

A unique capability of the scanners 10 is the ability to closely image non-planar surfaces such as the neck. I-123 and F-18 FDG can be used for imaging of involved lymph node or residues of thyroid cancer. The high-energy scanner is useful with FDG and the low-energy scanner for I-123.

The greatest difficulty with radio-guided parathyroidectomy is the relatively brief window of time in which ^{99m}Tc sestamibi is concentrated primarily in the parathyroid glands. While both thyroid and parathyroid tissue concentrate ^{99m}Tc sestamibi, the washout is faster from the thyroid gland, leaving an approximate 90-minute operative window for locating the diseased parathyroid gland. The development of a scanner 10 incorporating features of the present invention has alleviated some of the time constraints needed for radio-guided parathyroidectomy by allowing for a single intraoperative image of the adenomas, avoiding preoperative localization techniques and also quickening more definitive operative exploration. Even under the most experienced hands parathyroid adenomas are difficult to identify primarily because they have only 20-50% higher radioactivity than normal thyroid. The development of a more sensitive and specific scanner such as the device described herein has improved the accuracy rates. The surgeon can now utilize the scanner to locate the best site of incision (FIG. 5), verifying the cancerous tissue during the surgery, and to make sure that all cancerous tissue is taken out.

Another unique capability of the scanner 10 is its ability to acquire 3D information. By rotating the scanner around its own axis, as well as moving it on the surface of the neck, a “3-D” nuclear image of the radioactive tumor can be presented and the depth from the skin can be measured.

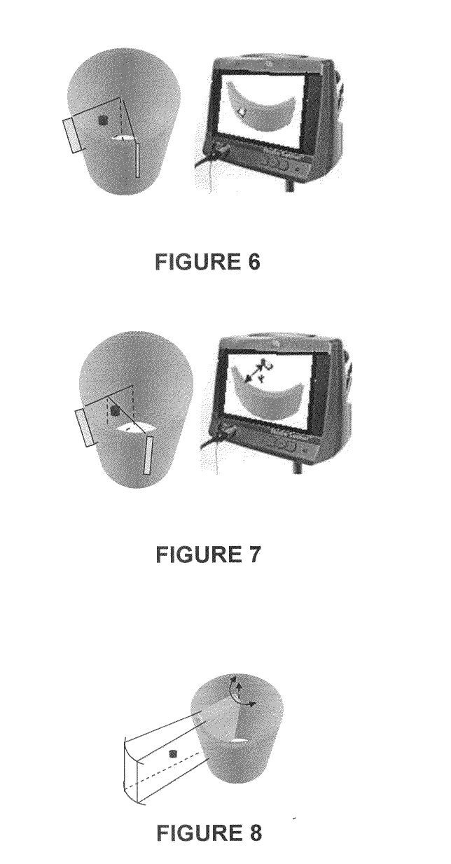

Recent studies suggested difficulties of pre-operative planar imaging of head-neck cancer, and suggested that a pre-operative SPECT-CT may be required to pin-point the sentinel nodes (T Wendler, A Hartl, T Lasser, J Traub, F Daghighian, S I. Ziegler, N Navab, Towards Intra-operative 3D Nuclear Imaging: Reconstruction of 3D Radioactive Distributions Using Tracked Gamma Probes; N. Ayache, S. Ourselin, A. Maeder (Eds.): MICCAI 2007, Part II, LNCS 4792, pp. 909-917, 2007.c_Springer-Verlag Berlin Heidelberg 2007) The scanner 10 has simplified detection of sentinel nodes in head-neck cancers. Because it is capable of imaging intra-operatively and real-time, as well as rendering the data in a 3-D presentation, containing the depth information (FIG. 6).

### Intra-Operative FDG Imaging

Many cancer patients have received a follow up with PET. Occurrence of a “hot Spot” in one of these follow-ups requires a biopsy. Finding tumor recurrence in a surgical field that has been the site of a previous surgery is difficult because many tissues now look “abnormal”. The surgeon can now benefited by using a high-energy gamma probe to find and verify the “hot tissues”, and then biopsy them. Background radioactivity and low tumor-to-background ratio, makes probe detection of FDG-avid tumors more difficult than sentinel node detection with Tc-99m. The high-energy gamma ray scanner disclosed herein facilitates FDG tumor detection in OR.

### Trans-Luminal and Rotational Scanning

One application of the intraoperative scanner disclosed herein has benefited post-prostatectomy patients who have a resin PSA with a negative bone scan and CT. Currently, trans-rectal biopsies are done with ultrasound guidance. However, often no suspicious lesion is seen and biopsies are little more than random samples. As a result, there is a low sensitivity rate. J591 is an anti-PSMA mAb that binds with high affinity (1 nm) to the extracellular domain of PSMAext allowing for targeting of viable prostate cancer cells and internalization. J591 was de-immunized to allow for repeated dosing, and has been administered to almost 300 patients at this point for both imaging and therapy. Over 100 patients were imaged with a gamma camera and In-111, and all sites of PC in virtually 100% of all the patients were detected. J591 has been labeled with Tc-99m as well as In-111. During Phase II studies we explored the unique capability of the proposed scanner 10 to image intra-luminally, explore its combination with ultrasound imaging and biopsy, and this gamma-camera has been evaluated in the endo-rectal imaging of the prostatic bed after radiolabled mAb administration to guide trans-rectal biopsy and improve the accuracy of this procedure.

### Sentinel Node Detection of Prostate Cancer

Recently the sentinel lymph node method has been implemented in prostate cancer for staging. Single-detector laparoscopic gamma probes are being used for this application, but the proximity of the prostate injection site to the sentinel nodes make detection difficult. The new scanner devices described herein provide intraoperative images of the abdomen and pelvic area and allow the sentinel nodes to be found faster and more accurately. Sentinel nodes for the prostate are typically located adjacent to very sensitive nerves which are important to erection as well as controlling continence. The precision afforded by imaging with the scanner incorporating features of the invention makes it possible to eliminate unnecessary cutting and reduction of these debilitating events. Minimally invasive prostatectomy can then be accomplished, providing better recovery, better maintenance of normal body functions and more accurate surgical outcomes.

### Three Dimensional Surface of the Surgical Field

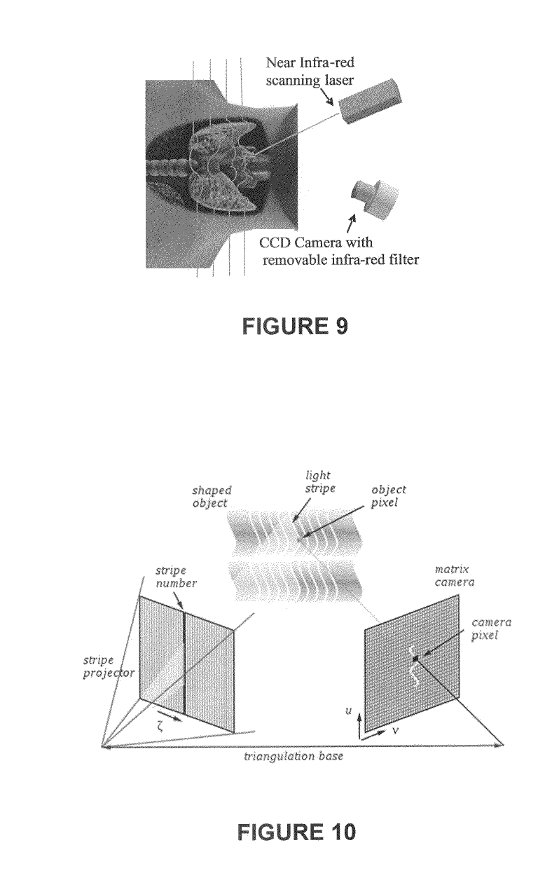

Referring to FIG. 9, a light pattern can be generated by fanning out a light beam into a sheet-of-light, generating several parallel straight lines on a planar surface. If a 3D object is placed under this surface, when viewed from an angle, these lines will look distorted. The observed distortions in the line can be translated into height variations. This is the basic principle behind depth perception for 3D machine vision. We have used this technique in the operating room, on the surgical field, by utilizing a near-infra-red laser beam (invisible to the eye). The CCD camera, while having a near-infrared filter, acquires the image of these distorted lines. The same CCD camera can be used to acquire pictures of the surgical field in the visible light region.

### 3-Dimensional Rendition of the Surface Using Structured Light:

Structured-light 3D scanner is a device for measuring the three-dimensional shape of an object using projected light patterns and a camera system. Projecting a narrow band of light onto a three-dimensionally shaped surface produces a line of illumination that appears distorted from other perspectives than that of the projector, and can be used for an exact geometric reconstruction of the surface shape (light section). A faster and more versatile method is the projection of patterns consisting of many stripes at once, or of arbitrary fringes, as this allows for the acquisition of a multitude of samples simultaneously. Seen from different viewpoints, the pattern appears geometrically distorted due to the surface shape of the object. (See FIG. 10).

Although many other variants of structured light projection are possible, patterns of parallel stripes are widely used. The picture shows the geometrical deformation of a single stripe projected onto a simple 3D surface. The displacement of the stripes allows for an exact retrieval of the 3D coordinates of any details on the object's surface. Two major methods of stripe pattern generation have been established: Laser interference and projection.

The laser interference method works with two wide planar laser beam fronts. Their interference results in regular, equidistant line patterns. Different pattern sizes can be obtained by changing the angle between these beams. The method allows for the exact and easy generation of very fine patterns with unlimited depth of field.

The projection method uses non-coherent light and basically works like a video projector. Patterns are generated by a display within the projector, typically an LCD (liquid crystal) or LCOS (liquid crystal on silicon) display.

A proprietary projection method uses DLP (moving micro mirror) displays. DLP displays do not absorb light significantly and therefore allow very high light intensities. They also have an extremely linear gray value reproduction, as they are steered by pulse length modulation.

Principally, stripes generated by display projectors have small discontinuities due to the pixel boundaries in the displays. Sufficiently small boundaries however can practically be neglected as they are evened out by the slightest defocus.

A typical measuring assembly consists of one stripe projector and at least one camera. For many applications, two cameras on opposite sides of the projector have been established as useful. In many practical implementations, series of measurements combining pattern recognition, Gray codes and Fourier transform are obtained for a complete and unambiguous reconstruction of shapes.

Another method also belonging to the area of fringe projection has been demonstrated, utilizing the depth of field of the camera ((Univ. of Stuttgart)). It is also possible to use projected patterns primarily as a means of structure insertion into scenes, for an essentially photogrammetric acquisition.

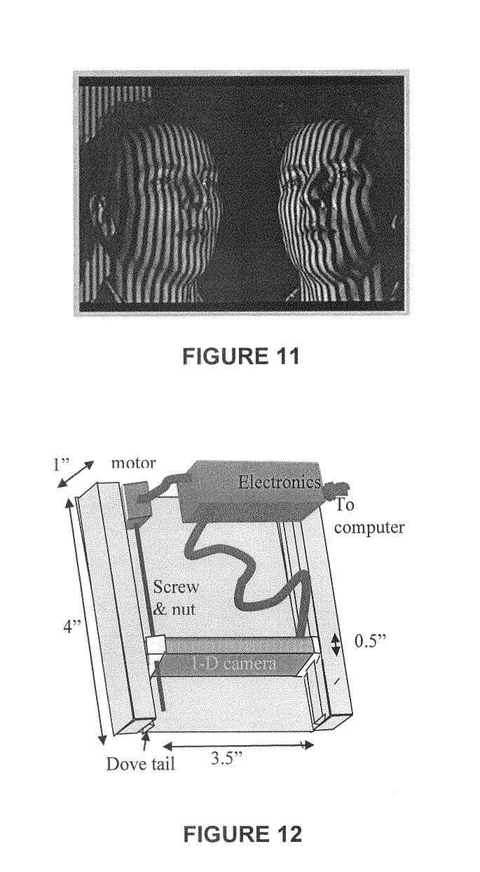

As the method can measure shapes from one perspective only at a time, complete 3D shapes have to be combined from different measurements in different angles. This can be accomplished by attaching marker points to the object and combining perspectives afterwards by matching these markers. Markers can as well be applied on a positioning device instead of the object itself. As an example, FIG. 11 shows a face shape acquisition taken by fringe projection. This technique has numerous applications:
Precision shape measurement for production control (e.g. turbine blades)
Reverse engineering (obtaining precision CAD data from existing objects)
Volume measurement (e.g. combustion chamber volume in motors)
Classification of grinding materials and tools
Precision structure measurement of grinded surfaces
Radius determination of cutting tool blades
Precision measurement of planarity
Documenting objects of cultural heritage
Skin surface measurement for cosmetics and medicine
Body shape measurement
Forensic inspections
Road pavement structure and roughness
Wrinkle measurement on cloth and leather
Measurement of topography of solar cells (see reference W J Walecki, et al. 2008)

### Collimator & Shielding Design for the Linear Camera

We utilize the standard formula for efficiency and resolution of parallel-hole collimators (Phelps & Sorenson 1979 chapter 16) to develop relevant planar camera estimates for the parameters. Table 1 summarizes some realistic parameters upon which to base the design of a collimator for the linear scanner. The configurations listed below are used for collimator testing. A 2 mm thick tungsten sheet provides adequate shielding. The total weight of the scanner depends on its length and at most is about 150 g.

TABLE 1
The spatial resolution and efficiencies of various tungsten collimators

| | Length | Gap between | thickness | FWHM | |
|---|---|---|---|---|---|
| # | cm | septa | of Septa | at 3 cm | Efficiency |
| A | 0.5 | 0.1 | 0.05 | 0.8 | 0.0016 |
| B | 0.5 | 0.07 | 0.04 | 0.55 | 0.0008 |
| C | 0.7 | 0.2 | 0.07 | 1.15 | 0.0037 |
| D | 0.7 | 0.1 | 0.03 | 0.57 | 0.00093 |
| E | 1 | 0.2 | 0.05 | 0.84 | 0.0021 |
| F | 1 | 0.1 | 0.02 | 0.42 | 0.00051 |

Photon Detector: The new model from Hamamtsu has a 3×3 mm active area, a 4×4.5 mm foot-print, and peak efficiency at 380 nm that is ideal for scintillation emissions of LaBr3:Cr scintillators (FIG. 16) that peak at the same wavelength.

Scintillator: The scintillator is a piece of LYSO, 5×0.4×2 cm for 511 keV, and 5×0.4×0.5 cm for 140 keV of Tc-99m. These dimensions can be modified as needed to optimize the efficiency and resolution). For example if the edge-packing is not resolved electronically then an alternative approach is to build pixilated scintillator arrays.

Electronics A small circuit board utilizing compact readout electronics was fabricated and the SSPM devices were attached to this board such as shown in FIG. 4a-c. The two resistors at both ends of the resistor chain can be varied to provide linear images. An electronics board equipped with two gain adjustable 120 ns Gaussian shaping amplifiers (Cremat, Inc), a timing single channel analyzer for creating a trigger (Ortec 406A), and a National Instruments DAQ housed inside a PC will digitize the peak of the analog signals. Similar electronic circuits have been built and used in similar arrays. The construction of these electronics is straight forward. The simulation studies of Moehrs et al. [21] demonstrated degradation in the spatial resolution and in the accuracy of locating the position of gamma rays that interact with the scintillator close to the edges of the slab. To address this problem we fixed extra SSPMs (FIG. 4a-c) on the side walls of the scintillator slab; this positioning provides improved response for those gamma rays that hit close to the edges. The resistor chain includes the SSPMs of the sides as well. The values of the resistors on the corners of the resistor chain were varied to optimize the linearity and position accuracy.

### Methods for Real-time Correction of Temperature Dependence

Method #1: A small thermocouple was mounted in contact with the SSPMs in order to measure the temperature in real time. The real-time measurement of temperature was acquired while varying the working voltage in order to achieve constant sensitivity in the 20 to 37 C range. This yields a look-up table for voltage to be applied to the SSPM for various temperatures. This lookup table was then implemented in software in order to control the working voltage in real time. The procedure was repeated with this real-time voltage control and the count rate vs. temperature was plotted from 20 to 37 C.

Method #2: A “Gain vs. Temperature” Look-up Table was created and implemented. The procedure was repeated but the voltage was held constant and the gain of the pre-amplifier varied to achieve a constant count rate across a range of temperatures between 20 and 37 C.

Method #3: Using Physical Chilling: Cooling the inside of the scanner through the use of Peltier Coolers was evaluated along with ventilation and sufficient insulation. The temperature was then measured inside the scanner while it was in an environmentally controlled chamber at temperatures between 20 to 37 C.

### Position Tracker Integration

Position tracker software was set to provide the position R(t) and the orientation O(t) of the 1-D scanner at any time and at 0.5 second intervals. The accumulated counts of each SSPM during the same period was used to generate a 1-D image, S(t). The length of the scanner is 50 mm, and its width is 3 mm. It was assumed that each 1 mm is 4 pixels. Therefore in order to represent the 1-D image of scanner at any time interval t, we drew a strip of 200×12 pixels (S(t)) on the computer screen, at the position R(t) and with orientation of O(t). At the next time interval (Δt=0.5 s) we drew another strip S(t+Δt) at the position R(t+Δt) at orientation O(t+Δt). If any pixels of these two strips overlap, then the mean of the two values, i.e.; [Si(t)+Si(t+Δt)]/2, was used to represent that pixel. If there is a gap between the pixels of S(t) and S(t+Δt), then interpolated values are assigned to those pixels. The 2-D non-planar image were presented in a standard 3-D coordinate. If the scanner moved too far, the software would re-scale the image. Real time imaging software written in C++ runs on the data acquisition computer. The performance of these tasks is well within the processing specifications of a standard PC computer.

Collimator & Shielding Design for the 511 keV Scanner We have considered in our preliminary analysis both pure gold and tungsten as septa material for the scanner. Since the task is to detect a hot-spot, the 5% inter-septa penetration be can be relaxed to about 10%. We again applied the formula of Phelps & Sorenson, 1979, ch-16. Testing was done using two configurations for gold. The volume of gold needed for each configuration is about 3.5 cc with a weight/collimator of about 2 ounces of gold.

Shielding is made of tungsten alloy, allowing for less than 5% penetration; using tungsten with density of 18.5 g/ml, the shielding weighs approximately 1400 g. An appropriate positioning support is necessary for intraoperative use of this scanner. We have worked with and tested a surgical instrument holder (the Kronner Low-Profile Scope Holder) from Kronner Medical of Oregon. It is suitable for compensating the weight of the high-energy scanner while allowing the surgeon to move it substantially freely. A similar functioning holder can be substituted. The Holder keeps the scanner firmly in position and thus frees the operators' hands for other tasks. The Holder attaches to the side rail of the operating table and can be located on either side of the table and thus away from the operating area. A telescoping arm holds the scanner. An electronic control is attached to the camera where it is readily accessible. Pressing a button on the positioning control releases the joints of the arm and allows for quick position changes. Button control can be done with the same hand as that used to move the scanner. The positioning mechanism of the scanner is driven by gas pressure which is generally available in operating room. It is not necessary to loosen multiple joints to reposition the scanner. All components of the positioning arm/holder, such as the controls, gas line, and connectors, can be autoclaved.

Electronics—A small circuit board utilizing compact readout electronics was fabricated with the SSPM devices attached to this board (FIG. 1). Two small surface mount amplifiers convert the current signal from the SSPM into a 50 ohm terminated voltage signal which is transmitted to the computerized data acquisition system. An electronics board equipped with two gain adjustable 120 ns Gaussian shaping amplifiers (Cremat, Inc), a timing single channel analyzer for creating a trigger (Ortec 406A), and an National Instruments DAQ housed inside a PC digitizes the peak of the analog signals. Similar electronic circuits have been built and used in other arrays.

### Housing Assembly and Shielding Assessment and Confirmation

We assembled the detector modules in their respective housings containing the appropriate shielding. A point source of radioactivity (100 microCi) was used to check the effectiveness of the side and back shielding of each scanner. First, the source was placed 2 cm below the collimator's face and the count rate was recorded. After this, the point source was moved to the side and then the back of the scanner, and any count rate greater than five percent of the one in front of the collimator was considered unacceptable. In this case more tungsten foils were added to areas that need more shielding.

Construction of the Moving Scanners—The feature of the scanner is that it is moveable freely in the surgical field, and its position is tracked by a position sensor. The scanner system, for example as shown in FIG. 12, was first tested by moving the scanner in the simplest form, i.e.; using a stepping motor controlled by a computer. On example of a suitable apparatus is available from Argus Inc. of Livermore, Calif. It has a motor (Model SSM-11-3-1), the Nema 11 Triple Stack Bipolar Stepper Screw Motor Spec 1, a stepper motor controller and a driver (ACE-SDE) with USB 2.0/RS-485 communication. It is stand-alone programmable and has a variety of controls for ramp and speed. It has digital outputs that provide the computer the position of the stage. Software takes 1-D images of the detector module, the position of the detector module, and forms a 2-D image of the radioactive distribution of the area under scan. This arrangement allowed us to cover a 5×5 cm area with these scanners.

The bottom plate of the stage is made of transparent plastic. A photographic digital camera is mounted on top to take optical images of the phantom sources below, and send them to the computer. A foot pedal switch (or a button on the side of the camera) simultaneously starts data acquisition from the position tracker, the moving stage, the gamma ray scanner, and the digital camera.

A clinically acceptable scanning time for this area of 5×5 cm is about 60 seconds with the scanner moving in 50 stages, one millimeter at the time with a dwell time of 1 second in each stage. There is some delay between stages and therefore the whole scan takes about 60 seconds. This is referred to as the “standard scanning speed” throughout the tests described below. In addition to forming an image with the position data given by the movable stage (Mi,j), we also form another image using the position data from the position tracker (called Ti,j.) The two images can be compared by subtraction from each other:

Di,j=Mi,j−Ti,j

Where Di,j represents any variance of image formed by the position tracker data Ti,j, verses the “gold standard” Mi,j, that is the image formed by the data from the movable stage. Di,j was analyzed for any significant non-statistical differences between the two images.

Superposition of Optical and Nuclear Images—Capillary tubes (50 mm long, 0.3 mm I.D.) were filed with Tc-99m solution (mixed with blue dye) to act as line sources. Ten of these sources were placed parallel to each other at various distances from each other. The scanner was placed on top of this phantom. Optical photographs were taken from the phantom simultaneous with the gamma ray imaging.

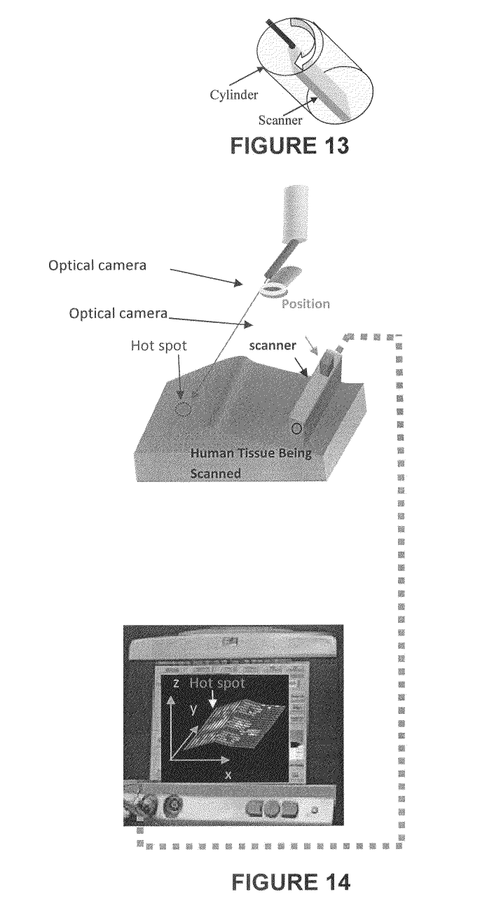

Rotational Scanning: The scanner was fixed in a tube as shown in FIG. 13. A stepping motor was used to rotate the scanner around one of its edges using the same computer controlled decoder described above. Such a rotational scanner can be readily inserted into a surgical opening or a body cavity where a full 360° scan of the surrounding tissue in a controlled and reproducible manner. When used in conjuction with mapping software the location/orientation of a radiation tagged source can be readily identified.

Computer-Controlled Laser Pointer—Pointing Location of “Hot Spot”—To intuitively guide the surgeon to the location of the radioactive foci, a laser pointer is mounted above the surgical field in open surgery. Also, an optical camera is attached. The laser pointer such as shown in FIG. 14 fixed to a telescopic arm is in communication with, is mounted on and is position controlled using a computer-controlled pan and tilt positioner. The telescoping laser pointer 90 such as shown in FIG. 16, is mounted, such as shown in FIG. 14, above the upper PET scanner arm 62 on a pivot 92 at the top of the central shaft 69 for rotation up to 360°. The pivot allows the laser pointer 90 to be rotated. The 360° tilt and rotation for the laser pointer 90 allows it to point to almost any location on the operating field. Computer-controlled motors move the laser pointer 90 and encoders track the position of the laser pointer.

I claim:

1. A hand held gamma camera comprises a one dimensional array of SSPM detectors coupled to a scintillator slab or an array of scintillators, the array having a position tracker, which provides data regarding the position of the scanner, attached to the array of SSPM detectors, said combination of SSPM detectors and scintillators configured to receive gamma rays from radiation labeled tissue and generate an output signal, said signal being fed to analysis software such that, in combination with the position tracker, a 1-D image is generated showing the location and the distribution of radioactivity of the of the radio labeled tissue in real time.
